(19) United States
(12) Patent Application Publication
(10) Pub. No.: US 2004/0250857 A1
(43) Pub. Date: Dec. 16, 2004

(54) Reducing valve for compressed gas bottles

(76) Inventor: Ernst Bernhard, Aegerten (CH)

Correspondence Address: WEBB ZIESENHEIM LOGSDON ORKIN & HANSON, P.C., 700 KOPPERS BUILDING, 436 SEVENTH AVENUE, PITTSBURGH, PA, 15219, US

(21) Appl. No.: 10/488,738

(22) PCT Filed: Jul. 8, 2002
(86) PCT No.: PCT/CH02/00368

(30) Foreign Application Priority Data
Sep. 7, 2001 (CH) 1665/01

(51) Int. Cl. G05D 16/06

(52) U.S. Cl. 137/505.42

(57) ABSTRACT

A reducing valve for compressed gas bottles comprises a valve mechanism for compressed gas bottles which is disposed between a high pressure connection and a low pressure output, whereby an opening which is defined by a sealing edge is sealed by a valve cone which is impinged upon by a closing force and which is preferably provided with a seal; and wherein means are provided in order to compensate the pressure imposed upon the valve cone in the region of the opening, comprising a compensation piston which is impinged upon by a pressure of the same strength in the opposite direction. The inventive reducing valve has a simplified structure and assembly, in addition to providing a high degree of functional reliability by virtue of the fact that the compensation piston is embodied as a piston which can move relative to the valve cone.

### TECHNICAL FIELD

The present invention relates to the field of the handling of gases which are under pressure. It refers to a reducing valve for compressed gas bottles according to the preamble of claim 1.

Such a reducing valve is known, for example, from the publication FR-A-1,168,455 (in particular, from fig. 1 there).

### PRIOR ART

Reducing valves for compressed gas bottles can be divided into two type classes, to be precise those with a rising characteristic and those with a falling characteristic. In reducing valves with a rising characteristic, the working pressure prevailing downstream of the reducing valve first increases when the bottle pressure decreases. This is the case with regard to reducing valves in which the closing operation is assisted by the supply pressure or bottle pressure. In reducing valves with a falling characteristic, the working pressure decreases with a falling supply pressure. This is the case with regard to reducing valvesin which the closing operation takes place counter to the supply pressure. Reducing valves of this type, because of their design, present a particular difficulty: in the reducing valve with a rising characteristic, for example, there is arranged, between the high-pressure inlet (supply pressure) and the low-pressure or working-pressure outlet, a valve in which a valve element is pressed sealingly against a sealing edge in the direction of flow. The valve element is opened in the opening direction, that is to say opposite to the direction of flow, and counter to the pressure of a spring acting in the closing direction, by means of a control pin which is connected to a regulating device equipped with a diaphragm. The supply pressure in the compressed gas bottle may amount to 300 bar and varies with an increasing emptying of the bottle. In the reducing valve with a falling characteristic, the conditions are exactly reversed, that is to say the valve element is pressed against a sealing edge opposite to the direction of flow. As a regulating device provided in this case is usually a regulating piston. As a result of these designs, the necessary opening or closing force of the sealing-off valve element varies, this being exhibited in a pressure rise (in a pressure reducing valve with a rising characteristic or a pressure reducing valve closing with the supply pressure) or in a pressure fall (in a pressure reducing valve with a falling characteristic or a pressure reducing valve closing counter to the supply pressure) of the working pressure.

This problem can be solved in that, on the one hand, a large regulating piston or a large diaphragm or, on the other hand, a sealing-off valve element with a very small diameter is installed. Where a large regulating piston is concerned, the valve becomes correspondingly larger, more unwieldy and heavier, not least because a much larger regulating spring also has to be installed. If the sealing-off valve element, also called a valve cone, which is selected is small, this results in a low throughflow.

The problem has been known for many years, and a corresponding number of proposals for solving it have been made, these concentrating essentially on compensating the pressure forces acting on the valve element. Thus, for example, it was proposed in U.S. Pat. No. 3,756,558 to connect to the valve element a compensating piston which is arranged displaceably in a cylinder bore. The cylinder bore is' connected on one side of the piston via a bore to the outside space and “on the” other side of the piston directly to the low-pressure outlet. However, the bore leading into the outside space has a disadvantage, because it can easily become clogged by dirt or the like in everyday operation. In particular, this solution requires two seals (on the valve element and on the compensating piston) which impede or completely prevent fine regulation.

The publication FR-A-1,168,455 initially mentioned or the corresponding GB-A-846,106 proposes, for compensation, that the valve element on the side opposite to the valve seat be designed as a piston which is displaceable in a cylinder space and a cross-sectional area of which is equal to the opening area of the valve orifice. The cylinder space is in this case connected to the low-pressure outlet of the reducing valve either via a duct running in the valve housin (FIG. 3) or via a duct led through the valve element (FIG. 1 or 2). The first of the two variants is comparatively complicated in terms of technical implementation, because the routing of the duct through the housing takes up additional space and requires special production steps. The second of the two variants, although being simpler and more compact, has, like the first variant too, another disadvantage which is associated with the design of the combined valve element/piston: since the valve element must at the same time run as a piston as an exact fit in the cylinder space and come to sit sealingly on the valve seat, it is necessary in the production and assembly of the parts of the reducing valve to have a high degree of accuracy which increases the cost of such a reducing valve correspondingly.

None of the known systems have apparently proved appropriate in practice. None of the known systems have consequently gained acceptance either. This means, in practice, that, with a fall in pressure in the bottle, it regularly becomes necessary to carry out an adjustment on the pressure regulating screw present on the regulating device.

### PRESENTATION OF THE INVENTION

The subject of the invention is, therefore, to provide a pressure reducing valve for compressed gas bottles with supply pressure compensation, which avoids the disadvantages of known reducing valves and, in particular, while at the same time having a simplified construction and assembly, is distinguished by high functional reliability.

The object is achieved by means of the whole of the features of claim 1. The essence of the invention is that a compensating piston designed as a piston moveable in relation to the valve cone is used. It is thereby possible in a simple way to decouple the valve function and the piston function and thus ensure the reliable functioning of the reducing valve, with production at the same time being simplified.

A first preferred embodiment is distinguished in that the valve cone has arranged in it a compensating space which acts as a cylinder space and into which the compensating piston penetrates, the cross-sectional area of the compensating space corresponding essentially to the area of the orifice bordered by the sealing edge. This design makes it possible to have a particularly compact construction of the compensating device. Preferably, the compensating space is sealed off outwardly by means of a seal surrounding the compensating piston.

The construction becomes particularly compact when, according to a preferred development, the compensating space is connected to the orifice bordered by the sealing edge by means of a presssure equalizing bore running in the valve cone.

High operating reliability is achieved in that the valve cone and the compensating piston are arranged one behind the other along an axis of the reducing valve, and in that the compensating piston is suspended flexibly with respect to the valve body in such a way that said compensating piston is displaceable transversely to the axis and/or is tiltable out of the axis. In particular, for the compensating piston a suspension is provided which comprises a coaxial flange which is attached to the compensating piston and by means of which the compensating piston is supported on a bearing surface, a cup spring which acts in the axial direction being arranged between the flange and the bearing surface.

The reducing valve has a rising characteristic when the valve cone is pressed in against the sealing edge by means of a conical spring from the high-pressure side and when the pressure exerting load on the valve cone in the regionof the orifice is the working pressure. In particular, the regulating device then comprises a regulating space which is connected to the low-pressure side and which is closed off outwardly by means of a diaphragm acted upon from outside by an adjustable regulating spring, the diaphragm acting on the valve cone counter to the pressure of the conical spring via a control pin. Thecompensating piston is in this case preferably suspended in a connecting nipple which is screwed into the valve body from the high-pressure side.

A particularly compact construction is also achieved in that the reducing valve is constructed essentially axially symmetrically to an axis extending in the longitudinal direction, and in that the gas flows from the high-pressure connection in the axial direction past the compens ating piston and the valve cone on the outside to the orifice bordered by the sealing edge.

A reducing valve with a falling characteristic is obtained when the valve cone is pressed in against the sealing edge from the low-pressure side and when the pressure exerting load on the valve cone in the region of the orifice is the supply pressure. The regulating device then preferably comprises a regulating space which is connected to the low-pressure side and which is closed off by a regulating piston acted upon from outside by a regulating spring, the regulating piston acting on the valve cone counter to the pressure of the regulating spring.

### BRIEF EXPLANATION OF THE FIGURES

The invention will be explained in more detail below with reference to an exemplary embodiment, in conjunction with the drawing in which:

FIG. 1 shows, in longitudinal section, a preferred exemplary embodiment of the reducing valve according to the invention which corresponds in construction to a reducing valve with a rising characteristic;

FIG. 2 shows, in longitudinal section, a reducing valve according to the prior art with a falling characteristic; and

FIG. 3 shows, illustrated in the form of a detail, the installation of a compensating piston according to the invention in a reducing valve according to FIG. 2.

### EMBODIMENTS OF THE INVENTION

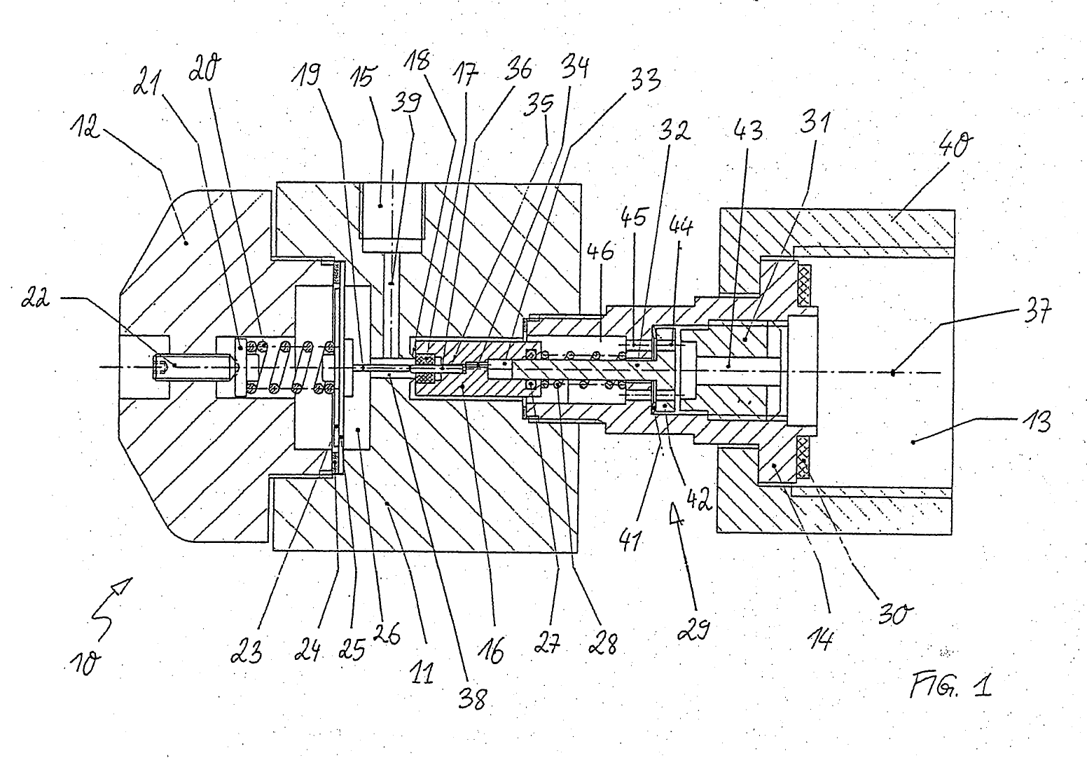

FIG. 1 illustrates, in longitudinal section, a preferred exemplary embodiment of the reducing valve according to the invention which corresponds in construction to a reducing valve with a rising characteristic. The reducing valve 10 is constructed essentially axially symmetrically to an axis 37 and has (on the right in this figure) a high-pressure connection 13 for connection to a compressed gas bottle (not illustrated). The reducing valve 10 comprises a (cylindrical) valve body 11, in which a central bore 38 is arranged coaxially to the axis 37. The central bore 38 is bordered at the high-pressure end by a circular sealing edge 18, onto which a (cylindrical) valve cone 16 presses with a conical seal 17 embedded into the end face. The valve cone 16 is acted upon in the closing direction by a conical spring. 28 which is supported on a connecting nipple 14 screwed into the valve body 11. An outlet duct 39 emanates laterally from the central bore 38 and issues into a laterally arranged low-pressure outlet 15.

Mounted parallel to the axis 37 in the valve cone 16 is a conical bolt 36, on which acts a control pin 19 extending concentrically through the central bore 38. The axial movement of the control pin 19 is controlled by a diaphragm 25 which is held between the valve body 11 and a valve cover 12 screwed into the valve body 11 from the left. A peripheral diaphragm ring 24 is arranged at the margin of the diaphragm 25. A regulating space 26 sealed off outwardly is thus formed on the right side of the diaphragm 25 and is connected to the low-pressure side via the central bore 38. The diaphragm 25 is acted upon from the side facing away from the regulating space 26, via a diaphragm plate 23 fitting on said diaphragm, by a regulating spring 20 which is supported on a regulating spring plate 21. The prestress of the regulating spring 20 can be set by means of a regulating screw 22 which is screwed into a threaded bore provided on the valve cover 12 and which acts on the regulating spring plate 21.

The connecting nipple 14 is equipped with a connecting seal 30 for connection to a compressed gas bottle. A union nut 40 is provided for fixing the reducing valve 10 mechanically to the compressed gas bottle.

The construction and functioning of the reducing valve are to that extent based on principles known per se. The novelty of the solution according to the invention lies in the type of supply pressure compensation. This is straightforward supply pressure compensation, that is to say the supply pressure on a surface of the valve cone 16 which corresponds to the surface covered by the conical seal 17 within the sealing edge 18 is replaced by a pressure which corresponds to the low pressure at the low-pressure outlet. The compensating piston 32 is used for this purpose. The compensating piston 32 penetrates axially displaceably into a compensating space 33 which is introduced into the high-pressure end of the valve cone 16 and which acts as a cylinder space. The cross-sectional area of the compensating space 33 or of the compensating piston 32 corresponds to the cross-sectional area of the central bore 38 bordered by the sealing edge 18. The compensating space 33 is sealed off relative to the high-pressure side by means of a sealing ring 27 surrounding the compensating piston 32. However, the compensating space 33 is connected to the central bore 38 via an axially parallel pressure equalizing bore 34 offset laterally out of the axis 37 and a pressure equalizing duct 35 leading laterally past the conical bolt 36, so that the same pressure prevails in the compensating space 33 as in the central bore 38.

The compensating piston 32 is suspended flexibly in the connecting nipple 14 by means of a special suspension 29, that is to say it can not only be displaced laterally out of the axis 37, but also tilted with respect to the axis 37. This is achieved, inter alia, in that, within the suspension 29, a cup spring 41 acting in the axial direction is arranged between a coaxial flange 42 integrally formed on the compensating piston 32 and an adjacent bearing surface of the connecting nipple 14, and the flange 42 is secured by means of a holding screw 31 screwed with a clearance into the connecting nipple 14. Axially parallel bores 43, . . . , 45 run through the holding screw 31, the flange 42 and the connecting nipple 14, through which bores the gas which is under high pressure flows axially out of the high-pressure connection 13 into a space 46 surrounding the compensating piston 32 and, from there, past the valve cone 16 on the outside into the region of the sealing edge 18.

It may be stated, in summary, that the present solution involves straightforward supply pressure compensation, that is to say the area which is covered by the conical seal 17 on the sealing edge 18 is directly compensated by the suspended compensating piston 32 of approximately the same size. There are no additional regulations by means of ducts and bores, as is the case in pilot-controlled valves.

If, in conventional valves, the bottle is full and the pressure is high, particularly in the case of 300-bar bottles, the valve cone is pressed onto the sealing edge with a force which is composed of the covered area×the pressure in the bottle (supply pressure)+the conical spring force. In this case, the necessary force of the regulating spring is very high, in order to open the valve cone counter to the gas pressure via the control pin. If the pressure in the bottle is a little above the working pressure, the closing force on the valve cone is much lower because the gas pressure is then low. However, the regulating spring continues to press with undiminished force, the result of which is that the pressure in the regulating space must be higher in order to achieve a closing of the valve cone.

This may be referred to as a rise in working pressure. If, then, in the solution according to the application, the high closing force, as a result of high gas pressure, is counteracted by cylinder and piston on which the gas pressure cannot act, the effective closing force is independent of the gas pressure. The variable supply pressure is thus compensated. A conical spring (28) then assumes the task of reliable closing. The effective diameter of the cylinder must correspond to the diameter of the sealing edge (18). Flow-related influences and the friction of piston and seal can be compensated by means of a slight deviation of the piston diameter of the compensating piston 32 with respect to the sealing edge diameter. A pressure equalizing bore 34 leads into the space (38), in which low pressure prevails, and causes the high pressure to become inactive over the area of the piston. The very low force on the front side of the piston as a result of working pressure can also be compensated at the diameter of the piston. After all the influences acting on the closing force are compensated and canceled, only the force of the conical spring 28 exerts a closing action on the valve cone 16. The conical spring 28, which acts as a closing spring, then has somewhat greater dimensioning.

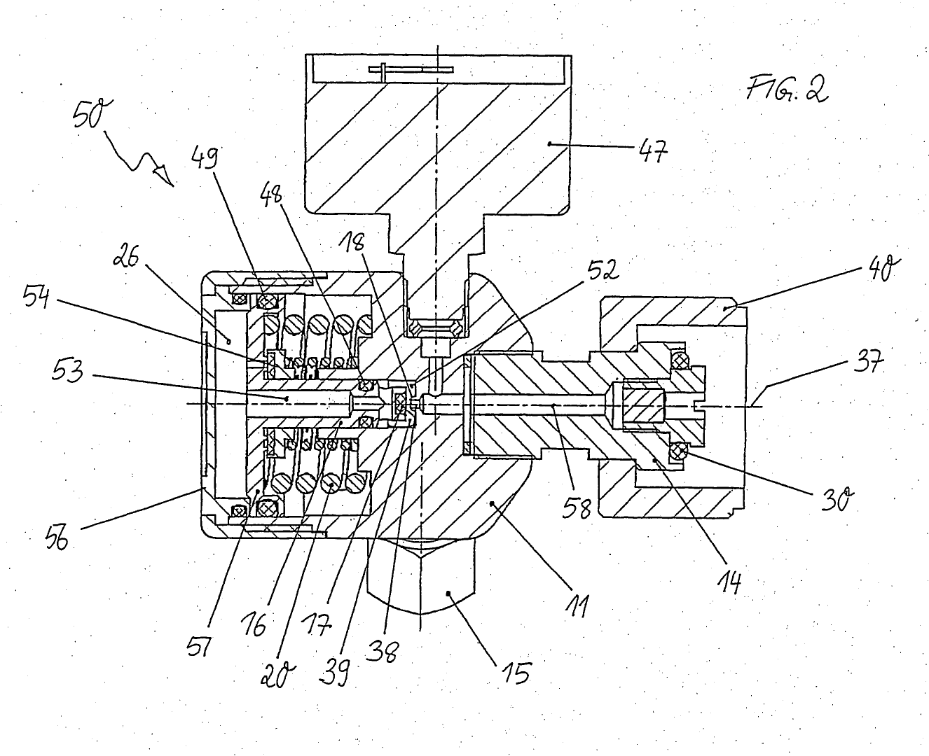

FIG. 2 illustrates by way of example, in longitudinal section, a reducing valve according to the prior art with a falling characteristic. Identical parts are in this case designated by the same reference symbols as in the reducing valve 10 from FIG. 1. The reducing valve 50 has a valve body 11, into which a connecting nipple 14 for connection to a compressed gas bottle is screwed in the axial direction from the high-pressure or supply-pressure side. A connecting seal 30 is again provided for sealing off. Fastening to the bottle is carried out by means of the union nut 40. Again provided at the center of the valve body 11 is an axial central bore 38 which is connected to the bottle outlet on the high-pressure side via a bore 58 in a connecting nipple 14. A pressure gauge 47, screwed into the valve body 11, for indicating the bottle pressure is connected to the bore 58.

The central bore 38 is bordered along a low-pressure side by a sealing edge 18, onto which a valve cone 16 equipped with a conical seal 17 presses with a closing action opposite to the direction of flow. The central bore 38 issues on the low-pressure side into a working-pressure space (low-pressure space) 52, from which an outlet duct 39 leads laterally to a low-pressure outlet 15. The working-pressure space 52 is sealed off outwardly by means of a seal 48 sitting on the valve cone 16. The valve cone 16 merges, at its end opposite to the sealing edge 18, into a regulating piston 51 which delimits the following regulating space 26 inwardly and which seals off the latter by means of a seal 49. The regulating space 26 is closed off outwardly by means of a cover 56. The regulating space 26 is connected to the working-pressure space 52 via a connecting duct 53 running axially in the valve cone 16, so that the working pressure acts on the regulating piston 51 and acts with a corresponding closing force upon the valve cone 16. In the example of FIG. 2, the underside of the regulating piston 51 has arranged on it a spring-loaded safety valve which, however, does not have any particular importance in connection with the present invention.

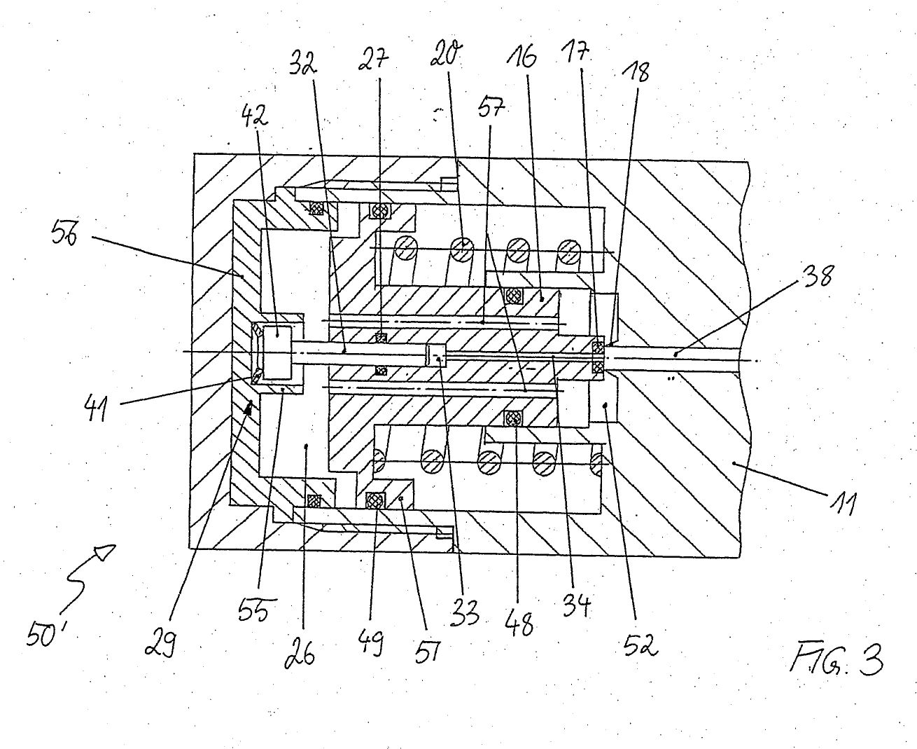

The force of a regulating spring 20 arranged between the regulating piston 51 and the valve body 11 acts counter to the closing force acting on the valve cone 16. The closing force is likewise counteracted by the supply pressure which exerts load on that surface of the conical seal 17 which is delimited by the sealing edge 18. It is this action of the supply pressure on the valve cone which can be neutralized by means of a compensating piston according to the invention. An exemplary embodiment of such compensation in the case of a reducing valve-according to FIG. 2 with a falling characteristic is reproduced in the form of an enlarged detail: in FIG. 3. In the reducing valve 50′shown in FIG. 3, just as in the exemplary embodiment of FIG. 1, a compensating piston 32 separate from the valve cone 16 is provided, which is displaceable in the axial direction in relation to the valve cone 16 and which penetrates into a compensating space 33 in the valve cone 16, said compensating space being sealed off by means of a sealing ring 27. The compensating space 33 has approximately the same diameter as the central bore 38 bordered by the sealing edge 18. The compensating piston 32, at its end facing away from the valve cone 16, has a flange 42 by means of which it is guided loosely in a receptacle 55 arranged on the cover 56. The flange 42 is supported on the cover via a cup spring 41 (suspension 29). By means of this type of mounting, the compensating piston 32 can execute equalizing lateral- and tilting movements, as already described above inconnection with FIG. 1.

The regulating space 26 is connected to the working-pressure space 52 by means of two eccentric bores 57 running in the valve cone 16. The compensating space 33 is connected to the central bore 38 via a central pressure equalizing bore 34 in the valve cone 16. Said compensating space is therefore under a pressure which is identical to the supply pressure. As a result, the pressure exerting load on the conical seal 17 in the opposite direction is compensated, and, consequently, dependence on the supply pressure is eliminated. By contrast, when, in the case of conventional reducing valves with a falling characteristic (closing counter to the supply pressure) according to FIG. 2, the bottle is full and the pressure is high, particularly in the case of 300-bar bottles, the valve cone 16 is pressed away from the sealing edge 18 with a force composed of the covered area×the pressure in the bottle (supply pressure). In this case, the necessary force of the regulating piston 51 for sealing off on the sealing edge 18 by means of the conical seal 17 is high, since the force just mentioned (covered area×pressure in the bottle (supply pressure)) is added to the force of the regulating spring 20. The pressure in the regulating space 26 is correspondingly higher than the valve pressure actually set by means of the regulating spring 20. When the pressure in the bottle is a little above the working pressure, the closing force on the valve cone 16 is much lower as a result of the low gas pressure, since the force which has to be added to the regulating spring force (covered area×pressure in the bottle) (supply pressure)) is lower. The pressure in the regulating space 26 is correspondingly lower. This may be referred to as a fall in working pressure.

The present invention is distinguished, overall, by the following features:

Flexibly suspended compensating piston. As a result, the piston of small valves can be adapted to the cylinder in the valve cone, without friction being generated at the conical guide as a result of manufacturing inaccuracies.

A spring or cup spring (41) in the suspension ensures that fine regulating movements of the valve cone can be executed, without the friction of the sealing ring, which is under high pressure, having to be overcome.

For large valves, it is conceivable that a fixedly suspended piston can assume the guidance of the valve cone which, in this case, is round on the circumference and does not have to be guided in the housing via a square piece.

The design is distinguished in that there is only one dynamically operating seal (27) giving rise to friction which may influence regulation.

The following applies particularly to reducing valves according to FIG. 1 with a rising characteristic:

Coaxial form of construction, in which the gas flows in the axial direction around the compensating piston, regulating spring and valve cone. This results in a particularly space-saving form of construction which can be installed, for example, in the connection piece of existing valves.

Axial pressure equalizing bore in the space of the working pressure, with the result that there is no need for an outwardly directed bore. By virtue of this arrangement, toxic or combustible gases do not pass into the surroundings if a sealing ring has become leaky, but, instead, are delivered to the consumer. In the case of valves with a small sealing edge diameter, a conical bolt is used which has longitudinally a fine groove by means of which pressure equalization can take place in the installed state.

LIST OF REFERENCE SYMBOLS

10, 50, 50′ Reducing valve (for compressed gas bottles).

11 Valve body

12 Valve cover

13 High-pressure connection

14 Connecting nipple

15 Low-pressure outlet

16 Valve cone

17 Conical seal.

18 Sealing edge

19 Control pin

20 Regulating spring

21 Regulating spring plate

22 Regulating screw

23 Diaphragm plate.

24 Diaphragm ring

25 Diaphragm

26 Regulating space

27 Sealing ring.

28 Conical spring

29 Suspension (compensatingpiston)

30 Connecting seal

31 Holding screw (compensating piston)

32 Compensating piston

33 Compensating space

34 Pressure equalizing bore

35 Pressure equalizing duct

36 Conical bolt

37 Axis

38 Central bore

39 Outlet duct

40 Union nut

41 Cup spring

42 Flange

43, . . . , 45 Bore

46 Space

47 Pressure gauge

48, 49 Seal

51 Regulating piston

52 Working-pressure space

53 Connecting duct.

54 Safety valve

55 Receptacle

56 Cover

57, 58 Bore

1-12. (cancelled).

13. A reducing valve for compressed gas bottles which comprises a valve body between a high-pressure connection and a low-pressure outlet, a valve mechanism, wherein an orifice bordered by a sealing edge is closed by a valve cone acted upon by a closing force and includes a seal, and further comprises means for compensating the pressure exerting load on the valve cone in the region of the orifice, wherein the means comprise a compensating piston acted upon by a pressure of equal size in the opposite direction, wherein the compensating piston is designed as a piston moveable in relation to the valve cone.

14. The reducing valve as claimed in claim 13, wherein the valve cone has arranged in it a compensating space which acts as a cylinder space and into which the compensating piston penetrates, wherein the cross-sectional area of the compensating space corresponds essentially to the area of the orifice bordered by the sealing edge.

15. The reducing valve as claimed in claim 14, wherein the compensating space is sealed off outwardly by means of a seal surrounding the compensating piston.

16. The reducing valve as claimed in claim 14, wherein the compensating space is connected to the orifice bordered by the sealing edge by means of a pressure equalizing bore running in the valve cone.

17. The reducing valve as claimed in claim 13, wherein the valve cone and the compensating piston are arranged one behind the other along an axis for the reducing valve, and wherein the compensating piston is suspended flexibly with respect to the valve body in such a way that said compensating piston is one of displaceable transversely to the axis and tiltable out of the axis.

18. The reducing valve as claimed in claim 17, wherein the compensating piston includes a suspension, wherein the suspension comprises a coaxial flange which is attached to the compensating piston, whereby the compensating piston is supported on a bearing surface, and wherein a cup spring acting in the axial direction is arranged between the flange and the bearing surface.

19. The reducing valve as claimed in claim 13, wherein the valve cone is pressed in against the sealing edge from the high-pressure side by means of a conical spring, and wherein the pressure exerting load on the valve cone in the region of the orifice is the working pressure.

20. The reducing valve as claimed in claim 19, wherein the regulating device comprises a regulating space which is connected to the low-pressure side and is closed off outwardly by means of a diaphragm acted upon from outside by an adjustable regulating spring, and wherein the diaphragm acts on the valve cone counter to the pressure of the conical spring via a control pin.

21. The reducing valve as claimed in claim 19, wherein the compensating piston is suspended in a connecting nipple, wherein the connecting nipple is screwed into the valve body from the high-pressure side.

22. The reducing valve as claimed in claim 19, wherein the reducing valve is constructed essentially axially symmetrically to an axis extending in the longitudinal direction, and wherein the gas flows from the high-pressure connection in the axial direction, past the compensating piston and the valve cone on the outside, to the orifice bordered by the sealing edge.

23. The reducing valve as claimed in claim 13, wherein the valve cone is pressed against the sealing edge from the low-pressure side, and wherein the pressure exerting load on the valve cone in the region of the orifice is the supply pressure.

24. The reducing valve as claimed in claim 23, wherein the regulating device comprises a regulating space which is connected to the low-pressure side and is closed off by a regulating piston acted upon from outside by a regulating spring, and wherein the regulating piston acts on the valve cone counter to the pressure of the regulating spring.

25. The reducing valve as claimed in claim 15, wherein the compensating space is connected to the orifice bordered by the sealing edge by means of a pressure equalizing bore running in the valve cone.

26. The reducing valve as claimed in claim 14, wherein the valve cone and the compensating piston are arranged one behind the other along an axis for the reducing valve, and wherein the compensating piston is suspended flexibly with respect to the valve body in such a way that said compensating piston is one of displaceable transversely to the axis and tiltable out of the axis.

27. The reducing valve as claimed in claim 15, wherein the valve cone and the compensating piston are arranged one behind the other along an axis for the reducing valve, and wherein the compensating piston is suspended flexibly with respect to the valve body in such a way that said compensating piston is one of displaceable transversely to the axis and tiltable out of the axis.

28. The reducing valve as claimed in claim 14, wherein the valve cone is pressed in against the sealing edge from the high-pressure side by means of a conical spring, and wherein the pressure exerting load on the valve cone in the region of the orifice is the working pressure.

29. The reducing valve as claimed in claim 16, wherein the valve cone is pressed in against the sealing edge from the high-pressure side by means of a conical spring, and wherein the pressure exerting load on the valve cone in the region of the orifice is the working pressure.

30. The reducing valve as claimed in claim 20, wherein the compensating piston is suspended in a connecting nipple, wherein the connecting nipple is screwed into the valve body from the high-pressure side.

31. The reducing valve as claimed in claim 20, wherein the reducing valve is constructed essentially axially symmetrically to an axis extending in the longitudinal direction, and wherein the gas flows from the high-pressure connection in the axial direction, past the compensating piston and the valve cone on the outside, to the orifice bordered by the sealing edge.

32. The reducing valve as claimed in claim 14, wherein the valve cone is pressed against the sealing edge from the low-pressure side, and wherein the pressure exerting load on the valve cone in the region of the orifice is the supply pressure.
